(19) United States
(12) Patent Application Publication
(10) Pub. No.: US 2021/0101811 A1
(43) Pub. Date: Apr. 8, 2021

(54) AERATED BIOFILM REACTOR HOLLOW FIBRE MEMBRANE

(71) Applicant: University College Dublin, National University of Ireland, Dublin, Dublin (IE)

(72) Inventors: Eoin CASEY, Dublin (IE); Eoin SYRON, County Mayo (IE)

(21) Appl. No.: 17/122,446

(22) Filed: Dec. 15, 2020

Related U.S. Application Data
(63) Continuation-in-part of application No. 15/124,927, filed on Sep. 9, 2016, now abandoned.

(30) Foreign Application Priority Data
Mar. 11, 2014 (GB) 1404274.1

(51) Int. Cl. C02F 3/20; C02F 3/10; B01D 63/04; B01D 65/02; B01D 69/02; B01D 69/08; B01D 71/70; C02F 3/12

(52) U.S. Cl. CPC C02F 3/208; C02F 3/102; C02F 3/109; C02F 3/106; B01D 63/04; B01D 65/02; B01D 2325/06; B01D 69/08; B01D 71/70; C02F 3/1268; C02F 2303/16; B01D 2319/04; B01D 2321/185; B01D 69/02

(57) ABSTRACT

The present invention is concerned with a fibre membrane for use in a Membrane Supported Biofilm Reactor (MSBR) or the like, the fibre membrane comprising a substantially cylindrical sidewall defining an internal lumen from which gas can permeate through the sidewall, and characterised in that at least a part of an outer surface of the fibre membrane is engineered to define at least one biofilm retaining region which acts to retain a quantity of biofilm therein, in particular when the fibre membrane is subjected to a high sheer biofilm control event, such as experienced during a reactor cleaning cycle, for removing excess biofilm in order to prevent clogging of the reactor.

### CROSS-REFERENCE TO RELATED APPLICATION

This application is a continuation-in-part of U.S. National Stage application Ser. No. 15/124,927, filed Sep. 9, 2016, entitled AERATED BIOFILM REACTOR HOLLOW FIBRE MEMBRANE, which claims priority to International Application Number PCT/EP2015/055047, filed Mar. 11, 2015, which is related to and claims priority to United Kingdom Patent Application Number GB 1404274.1, filed Mar. 11, 2014, the entirety of all of which are incorporated herein by reference.

### FIELD

The present invention is concerned with a fibre membrane for use in a Membrane Supported Biofilm Reactor (MSBR), or one embodiment of this reactor generally referred to as a membrane aerated biofilm reactor (MABR), a reactor utilising an array of such fibre membranes, in particular for the large scale treatment of effluent such as municipal wastewater or the like, and a method of controlling biofilm growth or thickness in such a MABR. It will however be appreciated that the fibre membrane of the invention may be used with any reactor which utilises one or more membranes to supply gas directly to a biofilm.

### BACKGROUND

In an MSBR, the biofilm is naturally immobilized on a gas permeable membrane. Oxygen or other gas diffuses through the membrane into the biofilm where oxidation of pollutants or biological reaction with other bio-available compounds, supplied at the biofilm-liquid interface, takes place. The gas supply rate is controlled by the intra-membrane gas partial pressure (a process parameter) and membrane surface area (a design parameter). The MABR concept, in which an MSBR is utilised for the treatment of municipal wastewater, is originally described in U.S. Pat. No. 4,181,604. Initial attempts at commercialising the technology proved unsuccessful due to difficulties controlling the thickness of biofilm on the membrane and the subsequent mass of biomass available for the treatment (removal of pollutants) of the wastewater.

Biofilms, which comprise a community of microorganisms attached to a surface, have long been exploited for wastewater treatment. Natural immobilization of the microbial community on inert supports allows excellent biomass retention and accumulation without the need for solid-separation devices. In the context of wastewater treatment, the ability of biofilm based processes to completely uncouple solids retention time (SRT) from hydraulic retention time (HRT) is especially useful for slow-growing organisms which would otherwise be washed out of the system, nitrifying biofilms being a case in point. Spatial stratification of biological populations also occurs in biofilms. With specific micro-organisms growing and becoming the dominant species in regions within the biofilm where suitable conditions exist. In traditional biofilm systems where biofilms grow on inert surfaces, the bottom regions of the biofilm can be anaerobic, in thick biofilm or in waters with low oxygen availability. The bottom regions can also be anoxic if ammonia is being oxidised in the upper regions and the nitrite/nitrate being produced diffuses to the base of the biofilm. The diffusion of nitrate/nitrite from the ammonia oxidising region in the biofilm to the base of the biofilm will occur if the bacteria there can utilise nitrate/nitrite as an oxygen source and there is sufficient carbon source available. Diffusion of the nitrate/nitrite will also take place into the bulk liquid until it reaches an equilibrium.

On membrane supported biofilms, the stratification of the biofilm is somewhat different, as the base of the biofilm, that is, the region attached to the surface, is aerobic. While the region at the surface of the biofilm at the interface with the water can be anoxic or anaerobic. This can promote a high rate of simultaneous nitrification/denitrification in the same reactor and the same biofilm, prevent the need for an additional post denitrification step or the recirculation of some of the wastewater back to the inlet.

Established biofilm processes, such as the trickling filter became popular in the 20th century because they offered simple, reliable and stable operation. Innovation in wastewater treatment technology is driven largely by the need to meet increasingly stringent regulatory standards and by the need to reduce the capital and operating costs of treatment processes. In recent years, these drivers have prompted the emergence of improved biofilm processes such as the Biological Aerated Filter (BAF) and the Moving Bed Biofilm Reactor (MBBR). One of the key advantages of biofilm-based processes is the potentially high volumetric reaction rate that can be attained due the high specific biomass concentration. Unfortunately, this advantage is rarely exploited in full-scale processes as a result of oxygen transfer limitations into thick biofilms. Biofilms in wastewater treatment systems are frequently thicker than the penetration depth of oxygen, typically 50 μm to 150 μm and, under high carbon-loading rates, the process becomes oxygen transfer rate limited. This problem, combined with the difficulty in controlling biofilm thickness has resulted in the application of biofilm technology predominantly for low-rate processes. Innovative technologies to overcome this problem are mainly based on methods that increase the specific surface area (particle based biofilm technologies), or on methods for increasing the oxidation capacity and efficiency, such as the membrane-aerated biofilm reactor (MABR).

Along with oxygen limitation in a biofilm treatment process, the mass transfer limitation of nutrients to and into the biofilm can also be an issue, especially in biofilm processes which have static media such as membranes. The presence of static media in the wastewater creates a drag on fluid flow through the reactor, hindering good bulk liquid mixing and creating laminar flow around the static media supporting the biofilm. The laminar flow over the biofilm surface allows for the formation of a large boundary layer hindering mass transfer to the membrane attached biofilm and the liquid around its surface, resulting in localised regions of poor mixing and reduced treatment rates. To overcome these poor mixing regions which can occur in static biofilm processes, targeted mixing, which may or may not be intermittent in nature, can be used to prevent regions in the reactor becoming stagnant and to promote the transfer of nutrients to the biofilm. Mixing can be carried out using mixers, jets or bubbles all of which increase the turbulence and shear force in the liquid and over the surface of the biofilm. Frequent targeted mixing is required to maintain a high reactor performance and encourage and promote mass transfer from the liquid to the biofilm.

Using air bubbles is an efficient way of mixing in a wastewater application, as bubbles continue to move up until reaching the surface of the liquid. They provide a lot of turbulence and mixing on a micro level. While bubbles are a very efficient way of promoting mass transfer they are also a very effective way of removing biofilm from surfaces.

The size of the bubbles used for mixing and for scouring and the intensity of the air flow around the membranes is an important parameter. Bubbles for scouring or cleaning of membranes are coarse bubbles which have a diameter greater than 6 mm. The scouring intensity used for membrane cleaning is very high with intensities of 0.005 up to 8 m3 m-2 h-1 reported in studies on biofouling removal. The shear forces associated with this scouring can also be increased due to the air lift effect which can occur in membrane modules. The air lift occurs when air is introduced into a liquid column in fluid communication with another liquid column without air. The lower density of the air liquid mixture creates a flow of liquid from the higher density liquid only column to the column with an air liquid mixture. The resulting upward liquid velocity and the velocity of the rising bubbles in the air liquid mixture column, result in greater shear forces around the outside of the bubbles, improving the removal of biofilm and biofouling. For mixing in a membrane module bubbles can also be used, however these bubbles are generally smaller in size (medium bubbles) and the intensity with which the air is introduced into the reactor is significantly less. In a membrane supported biofilm these bubbles, as well as providing bulk liquid mixing, disturb the liquid boundary layer which forms over the surface of the membrane supported biofilm and prevents good mass transfer between the bulk liquid and the biofilm.

Achieving a balance between establishing good mixing in a MABR while at the same time not causing the removal of the biofilm is difficult, and operators and designers in the goal to improve performance can over mix a system, detaching too much biofilm, resulting in the loss of performance.

Microporous membranes for the filtration of water and wastewater trace back to the 1960's. They have become a common technology in the water process industry throughout the world. Microporous membranes for filtration operate on the principle that water passes through the membrane pores and the solid particles are retained on the retentate side. The main focus for filtration membranes is the prevention of fouling. Much work has gone into developing new materials and new strategies to prevent and minimise the accumulation of bio-solids and prevent and remove any biofilm growth. In full-scale applications of membranes for the filtration of wastewater coarse bubbles are used to remove fouling and biofilm and keep the surface of the membrane clean. This keeps the flux (liquid passing through the membrane per unit surface area) high. Membranes used for water filtration contain pores through which water can pass. The pores are typically formed in the casting or spinning of the membrane. This is where the polymer from which the membrane is formed is dissolved in a solvent and the solution is allow to flow through an annulus to produce a hollow fibre, or flow onto a surface to create a flat sheet. The polymer is then allowed to crystallise through the removal of the solvent, for example in a water bath or through the cooling of the solution. The pores are formed during this crystallisation process.

This process is outlined in more detail in US Patent application US 2003/0140790A1 (Herczeg) which discloses a convoluted surface hollow fibre membrane, as well as outlining the method of manufacturing the hollow fibre membrane with a convoluted surface, and identifies that the convoluted surface provides additional surface area, which is available for filtration. The sole advantage of the convoluted surface is to provide additional surface area for filtration purposes, not biological processing, and in such filtration medium it is crucial that the surfaces are kept clean and clear of any fouling material which would have a detrimental impact on filtration performance. While the patent does mention the importance of cleaning of hollow fibre membranes systems it also highlights that some membranes are difficult to clean especially in devices including a plurality of hollow fibres. While Herczeg discloses that the novel membranes can be cleaned with solutions, no mention is made about the scouring of the membranes to remove biofouling, and the convoluted surfaces proposed would prove difficult to clean using only bubbles. For gas permeable membranes it is not necessary to form a porous structure as the gas molecules permeate through the molecular structure of the membrane itself. The convoluted porous surfaces are permeable e.g. active in that fluid passes through the surfaces. Accordingly the convolutions provide active surface area available for filtration.

The incorporation of membranes for aeration in wastewater treatment reactors can also be traced back several decades when Schaffer et al (1960) reported the use of plastic films of unspecified material for oxygenation of a wastewater. Visible biological growth was observed on the polymer and it was reported that this had no observable effect on the oxygen transfer rate. It was not until 1978 when Yeh and Jenkins (1978) reported results of experiments with Teflon tubes in synthetic wastewater, that the potential of the membrane for oxygenation was recognized. This work was inspired by the emergence of hollow-fibre oxygenation systems for cell and tissue culture in the early 1970s. By 1980 the first patent was issued for a hollow fibre wastewater treatment reactor in which the biological oxidation takes place on the surface of micro-porous membranes.

The MABR has several advantages over conventional biofilm technologies;

1. Comparatively high volumetric carbon oxygen demand (COD) removal rates are achievable if pure oxygen is fully exploited and if biofilm thickness-control measures are in place.

2. Bubbleless aeration offers the potential for significantly higher oxygen utilization efficiencies with consequent energy savings. In addition, reduced air stripping during the bio-treatment of volatile organic compounds is possible.

3. Simultaneous nitrification, denitrification and COD removal can be achieved at comparatively higher rates due to the unique microbial population stratification.

4. Specialist degrading microorganisms, such as ammonia oxidizing bacteria, tend to be preferentially located adjacent to the biofilm-membrane interface thereby enhancing their retention by protection from biofilm erosion.

Despite this potential the concept remained in the lab setting due to technical issues around long term process performance. Hundreds of research articles concerning both fundamental and applied aspects of the MABR have been published for a range of wastewater treatment application areas and the number of publications has surged dramatically in the past couple of years. The increased interest in the MABR has arisen perhaps due to a realization that it is a technology that can both achieve process intensification in wastewater treatment as well as offering the potential for significant energy cost savings.

A number of full-scale installations have taken place in recent years, where the membrane modules have been retrofitted to existing wastewater treatment systems to provide additional biomass and aeration capacity. This has allowed wastewater treatment plant operators to upgrade the capacity of their treatment systems incrementally without large capital expenditure.

To ensure the MABR can compete in the Wastewater treatment marketplace there is a critical need to ensure that the oxygenation membranes have high oxygen permeability, are robust, cost effective and suitable for the immobilisation of biofilm. If the MABR is to achieve the potential indicated by laboratory scale trials, several technical challenges need to be overcome. The primary obstacle to full scale implementation has been the problem of excess biomass control which can lead to significant performance deterioration.

There are a number of patents relating to MABR technology, however none of these incorporate effective biofilm control technology. EP2361367 aims to tackle the issue of biofilm control by providing the basis for determining when it is necessary to instigate the biofilm control. The disclosure considers how to measure and determine the biofilm thickness on the membranes through the use of an inert gas diffusing through both the membrane and the biofilm. It can help an operator decide when to implement the biofilm control procedure. It can also determine how much biofilm has been removed after a control procedure, however it does not allow help in achieving the appropriate biofilm thickness during the control procedure. Therefore there is a level of risk associated with instigating a biofilm control procedure. If it is not done effectively then the procedure will have to be repeated, and if it is too aggressive too much biofilm is removed reducing the quantity of biomass in the reactor, and potentially removing the anoxic bacteria and anoxic region of the biofilm, resulting in the loss of denitrification. In light of the method disclosed in EP2361367 to determine when biofilm control takes palace, it becomes necessary to prevent complete biofilm removal during the biofilm control procedure.

This is the paradox of the MABR, in that from a bio-catalytic point of view the more biofilm the better the reactor performs, however above a certain limit the accumulation of biofilm can cause severe problems with liquid flow distribution. The ideal MABR will operate in a cyclical manner with biofilm accumulation, partial removal and re-growth. In order to maintain the biofilm in the optimum range a mechanism to prevent complete biofilm detachment during the control operation is required. Many of the laboratory scale studies reported to-date in the literature were operated with low membrane packing densities and thus, the problem of biomass control was not prioritized. In assessing the prospect of the technology it is necessary to carefully examine the results of prior studies where modules were trialled using membrane packing densities high enough to be realistic for commercial application of MABR technology. Invariably these studies (Semmens et al, 2003, Semmens, 2005) have shown that significant clogging of the membrane module occurs, usually after several weeks or months of operation. This problem of excess biomass formation is concomitant with deterioration in the performance of the reactor in meeting its pollutant removal efficiencies.

U.S. Pat. No. 4,181,604 (issued on Jan. 1, 1980), describes a module having several loops of hollow fibre porous membranes connected at both ends to a pipe at the bottom of a tank containing wastewater. The pipe carries oxygen to the lumens of the membranes and oxygen diffuses through the membrane pores to an aerobic biofilm growing on the outer surface of the membranes. In U.S. Pat. No. 4,746,435 the same apparatus is used but the amount of oxygen containing gas is controlled to produce a biofilm having aerobic zones and anaerobic zones. U.S. Pat. No. 6,558,549 describes an apparatus for treatment of wastewater where a biofilm is cultivated on the surface of non-rigid (sheet like) planar gas transfer membranes immersed in the wastewater tank in the vertical direction. The invention is an immersion type membrane system possibly for use in wastewater retrofit applications. There is however no effective means of biofilm thickness control. An air bubble scouring method is unlikely to be effective, and may remove all of the biofilm thereby impinging process performance.

U.S. Pat. No. 5,403,479 describes an in situ cleaning system for fouled membranes. The membrane is cleaned by a cleaning fluid containing a biocide. U.S. Pat. No. 5,941,257 describes a method for two-phase flow hydrodynamic cleaning for piping systems. U.S. Pat. No. 7,367,346 describes a method for cleaning hollow tubing and fibres. These three patents are applied for the cleaning hemodialyzers used for dialysis and hollow fibre modules used in water treatment and separations. They are not applicable to systems where the material to be cleaned is acting as a biocatalyst and do not have any form of process sensing linked to the cleaning method.

US Patent Application 2006/0096918A1 discloses configuring fibre membranes into a weave or mat such that the biofilm which grows on the adjacent membranes forms a filter. Instead of the biofilm solely removing dissolved components the flow of water through the biofilm in between the membranes, can act as a bio-filter, removing particulate matter similar to the operation of other membrane filtration devices. Biofilm control is discussed, and it highlights that conventional methods of shearing biofilms are difficult to use in order to reliably and consistently maintain biofilms of specific thickness.

“Aeration and hydrodynamics in submerged membrane bioreactors” (Journal of Membrane Science; 379(2011)1-18) by Braak et al discusses membrane fouling and the importance of aeration for the cleaning of Membrane Biofilm Reactors, where the membranes are used for filtration. The article reviews both experimental studies and computational fluid dynamics simulations and notes that gas velocities, bubble characteristics (shape, size, frequency), aeration design and homogeneity are the main issues in using aeration for fouling prevention.

The present invention seeks to provide an improved hollow fibre membrane for use with membrane aerated biofilm reactors.

### SUMMARY

According to a first aspect of the present invention there is provided a biofilm reactor fibre membrane comprising an internal lumen from which gas can permeate through the membrane; characterised in that at least a part of an outer surface of the fibre membrane is engineered to define at least a pair of protrusions which define at least one engineered biofilm retaining region therebetween, each protrusion having a height of between 10 μm and 500 μm above the nadir of the defined biofilm retaining region.

Preferably, the outer surface of the fibre membrane defines an array of the protrusions and corresponding engineered biofilm retaining regions.

Preferably, the engineered biofilm retaining region of the outer surface comprises one or more concave regions.

Preferably, the outer surface comprises two or more substantially radially extending protrusions.

Preferably, the engineered biofilm retaining region of the outer surface comprises one or more substantially longitudinally extending corrugations.

Preferably, the outer surface of the fibre membrane is multilateral.

Preferably, an inner surface of the fibre membrane, which defines the lumen, is shaped to optimise gas transfer through the membrane.

Preferably, the fibre membrane is formed as a polymer extrusion.

Preferably, the fibre membrane comprises an open end through which gas may be supplied to the lumen.

Preferably, the fibre membrane comprises a second open end through which exhaust gas can be removed.

Preferably, the outer surface defines a cylindrical sidewall surrounding the lumen.

Preferably, the fibre membrane has an external diameter in the range of between 150 μm and 1500 μm.

Preferably, the fibre membrane comprises a gas permeable polymer.

Preferably, the fibre membrane comprises polydimethyl siloxane (PDMS).

According to a second aspect of the present invention there is provided a membrane aerated biofilm reactor comprising a reactor vessel; a plurality of hollow fibre membranes according to the first aspect of the invention located in the reactor vessel; a liquid inlet arranged to feed a liquid to be treated into the reactor vessel; and a liquid outlet from which treated liquid can be withdrawn from the reactor vessel.

Preferably, the reactor comprises a process gas inlet for supplying a process gas to the lumen of the fibre membranes.

Preferably, the reactor comprises a scour gas inlet for introducing a scouring gas into the vessel to effect biofilm removal from the membranes.

Preferably, the scour gas inlet is adapted to generate bubbles of the scouring gas.

Preferably, the bubbles are dimensioned to have a diameter which prevents the bubbles from contacting the nadir of the biofilm retaining region of the membranes.

Preferably, at least an open end of each fibre membrane is captured in an anchor.

Preferably, the fibre membranes are arranged in groups.

According to a third aspect of the present invention there is provided a method of controlling biofilm thickness in a membrane aerated biofilm reactor which has an array of fibre membranes each comprising an internal lumen from which gas can permeate through the membrane, at least a part of an outer surface of each fibre membrane comprising a pair of space apart protrusions which define at least one engineered biofilm retaining region therebetween, the method comprising scouring excess biofilm from an external surface of the membrane using gas bubbles dimensioned to prevent contact with a nadir of the defined biofilm retaining region.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 illustrates a cross section of a conventional prior art hollow fibre for use in a membrane aerated biofilm reactor;

FIG. 2 illustrates a cross section of an aerated biofilm reactor membrane fibre according to a preferred embodiment of the present invention;

FIG. 3 illustrates a cross section of an alternative aerated biofilm reactor membrane fibre according to an aspect of the present invention;

FIG. 4 illustrates a cross section of another alternative aerated biofilm reactor membrane fibre according to the present invention;

FIG. 5 illustrates a reactor according to a further aspect of the present invention;

FIG. 6 illustrates the membrane fibre of FIG. 1 with an excess accumulation of biofilm on an exterior surface thereof;

FIG. 7 illustrates the membrane fibre of FIG. 6 following removal of a quantity of biofilm from the exterior surface thereof;

FIG. 8 illustrates the membrane fibre of FIG. 6 with biofilm remaining only in a plurality of engineered biofilm retaining regions;

FIG. 9 illustrates a schematic representation of a large diameter bubble of scouring gas in contact with a pair of membrane fibres according to the invention; and

FIG. 10 illustrate a schematic representation of a smaller diameter bubble of scouring gas in contact with the pair of membrane fibres according to the invention.

### DETAILED DESCRIPTION

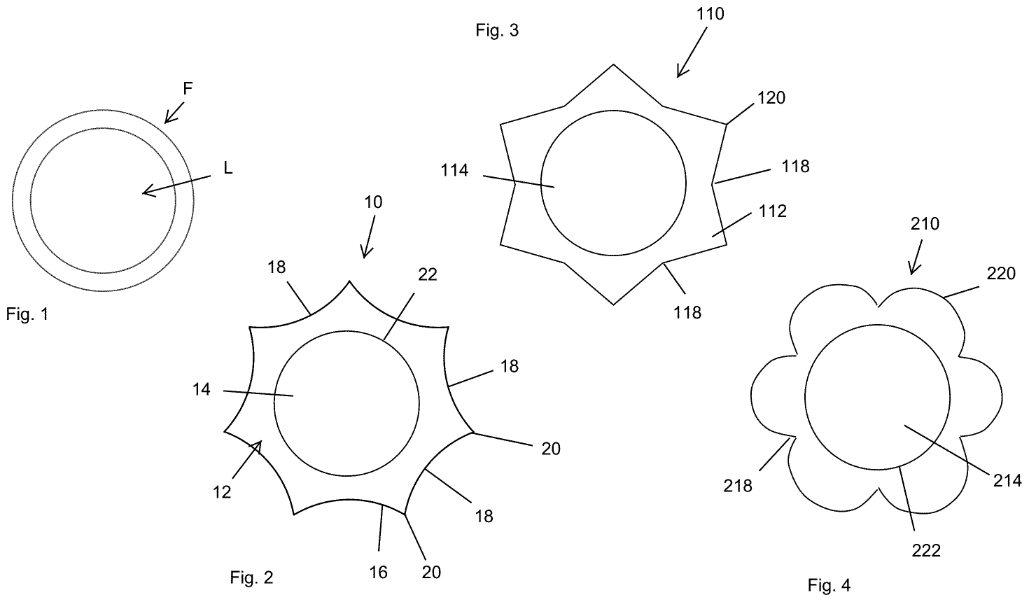

Referring now to FIG. 1 there is shown a cross-section of a conventional prior art hollow fibre F for use in a conventional membrane aerated biofilm reactor (not shown). The hollow fibre F is substantially cylindrical in cross-section and defines an interior lumen L through which gas such as oxygen, air, oxygen enriched air, hydrogen or any other suitable gas, may be supplied, and which then permeates through the sidewall of the hollow fibre F in order to, in use, oxygenate a biofilm colonising the outer surface of the hollow fibre F. It can be seen that the outer surface of the hollow fibre F is a substantially smooth and continuous surface.

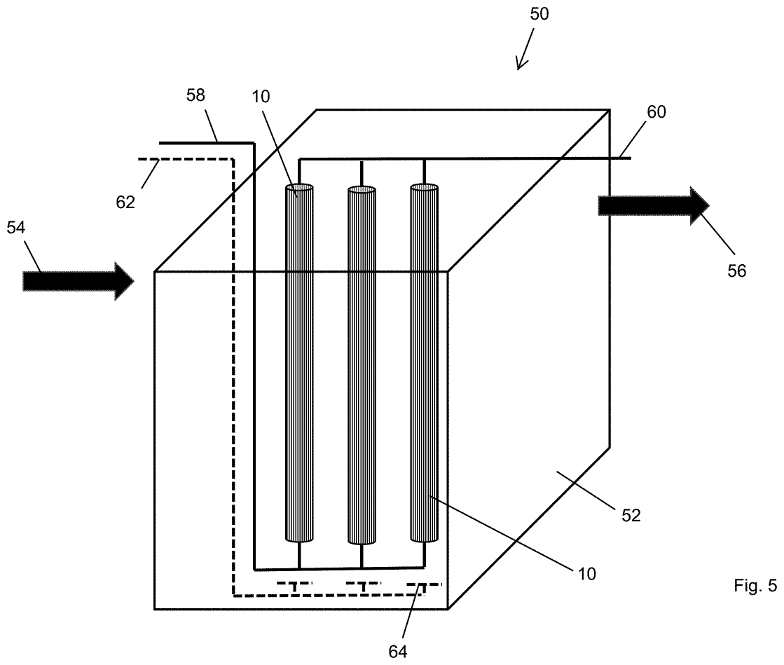

Turning then to FIG. 2 there is illustrated a cross-section of a fibre membrane for use in a membrane aerated biofilm reactor 50 (FIG. 5), the fibre membrane being generally indicated as 10. The fibre membrane 10 comprises a substantially cylindrical side wall 12 which is generally annular in form, and thus defines an interior lumen 14 which extends longitudinally of the fibre membrane 10. In use a gas such as oxygen or the like is pumped into the lumen 14 and, by providing the sidewall 12 as a gas permeable material, the gas can permeate through the sidewall 12 to be supplied to a biofilm (not shown in FIG. 1) colonizing an outer surface 16 of the fibre membrane 10. Unlike prior art hollow fibres, the fibre membrane 10 of the present invention defines one or more, and preferably a plurality of, engineered biofilm retaining regions 18 which, as described in detail hereinafter, act to retain a quantity of biofilm therein, in particular when the fibre membrane 10 is subjected to a high sheer biofilm control event, such as experienced during a reactor cleaning cycle, for removing excess biofilm in order to prevent the issues discussed above. As a result, once such an event has been completed, the biofilm held in the retaining regions 18 ensure expedient regrowth of the biofilm to full operational levels, thus significantly reducing the lead time between such a cleaning event and a return to full operation of the reactor 50. Conventionally this would be a significantly longer period in order to facilitate reseeding of the biofilm and regrowth on the outer surface of the fibre to an operational level.

Unlike prior art fibres, in the FIG. 2 embodiment the outer surface 16 is multilateral, and includes a plurality of concave sides each of which defines a single biofilm retaining region 18 located between an adjacent pair of protrusions 20. It can be seen that an inner surface 22 of the sidewall 12 is circular but could also be multilateral, for example corresponding in number of sides to that of the outer surface 16. It will of course be appreciated that the shape of both the outer surface 16 and inner surface 22 may be varied as required. For example it may be preferable that the outer surface 16 and inner surface 22 are substantially parallel in order to provide the side wall 12 with a substantially uniform thickness, thereby ensuring an equal transfer of gas at all points around the side wall 12, in order to establish an equal growth rate of biofilm about the outer surface 16. Equally however it will understood that it may be desirable to encourage regions of increased or decreased biofilm thickness on the outer surface 16, by suitably altering the gas permeability of that region of the sidewall 12, for example by varying the thickness of the sidewall 12 at localised regions. The fibre membrane 12 preferably has a external diameter in the range of between 0.2 mm to 5 mm, more preferably between 0.35 mm and 0.9 mm, and most preferably 0.5 mm, which diameter is measured at the radially outmost extremity of the fibre membrane 12.

The engineering biofilm retaining regions 18 are preferably substantially concave in shape, although as described below other forms are also envisaged. Regardless of the profile of the retaining region 18, the effective depth, that is the distance from the tip or radially outermost point of the respective protrusions 20 to the nadir or lowermost point in the concave or otherwise depressed retaining region, is in the range of between 10 μm and 500 μm. This depth will vary depending on various operating parameters, in particular the amount of biofilm to be retained following a high shear event, and/or the mechanism by which the high shear or cleaning event is achieved, for example by gas scouring or the like, as detailed below.

The fibre membrane 12 is preferably produced by extruding a polymer through a suitably shaped die (not shown) to provide the desired external and internal profiles to the fibre membrane 10. It will however be immediately understood that any other suitable method of manufacturing the fibre membrane 10 may be employed, and the material or combination of materials selected to form the fibre membrane 10 may be varied. The fibre membrane 12 is preferably comprised of silicone (polydimethyl siloxane (PDMS)) Or a modified version of PDMS, although other suitable materials may be employed.

Referring to FIGS. 3 and 4 there are illustrated alternative embodiments of a fibre membrane according to the present invention and for use in a MABR, each variant providing an alternative sidewall profile, as dictated by the shape of an outer surface and/or an inner surface of the respective fibre membrane.

In particular, referring to FIG. 3 there is illustrated a fibre membrane 110 similar in cross-section to the fibre membrane 10 of the first embodiment, comprising a star shaped sidewall 112 surrounding an inner lumen 114. A plurality of engineered biofilm retaining regions 118 are defined between pairs of protrusions 120 on the side wall 112, the retaining regions having sloping sidewalls terminating at a central apex defining the nadir of the retaining region 118.

FIG. 4 illustrates a fibre membrane 210 which is again multi-lateral in form, defining six convex sides forming protrusions 420 and a substantially circular inner surface 422 defining a lumen 214. A plurality of engineered biofilm retaining regions 218 are again defined between adjacent protrusions 220.

In each of the above fibre membranes at least one, and preferably an array of, biofilm retaining regions are defined about an outer surface of the fibre membrane, such that during a high sheer event such as a biofilm control event in order to prevent clogging of a reactor, some level of biofilm is retained in the retaining regions on the outer surface of each fibres membrane, in order to facilitate a speedy regrowth of the biofilm following the high shear event, in order to allow the reactor to be fully operational in a reduced period of time.

Turing then to FIG. 5 there is schematically illustrated a MABR reactor according to an aspect of the present invention, and generally indicated as 50. The reactor 50 comprises a reactor vessel 52 which may be of any suitable size and shape, contained within which are multiple arrays or groups of the fibre membranes 10, only three of which groups or bunches are shown for illustrative purposes. In the preferred embodiment illustrates the fibre membranes 10 are arranged in a substantially vertical orientation in use, that is a longitudinal axis of each fibre membrane 10 extends substantially vertically through the vessel 52. A liquid inlet 54 supplies wastewater to be treated to the interior of the vessel 52 while a liquid outlet 56 is provided for removing treated wastewater.

A process gas inlet 58 supplies gas to the lumen (not shown) of each of the fibre membranes 10, which process gas may be air, and which then passes through the sidewall of the fibre membranes to feed the biofilm growing on the exterior surface of each fibre membrane 10. A process gas outlet 60 is provided to exhaust gas from the interior of the vessel 52.

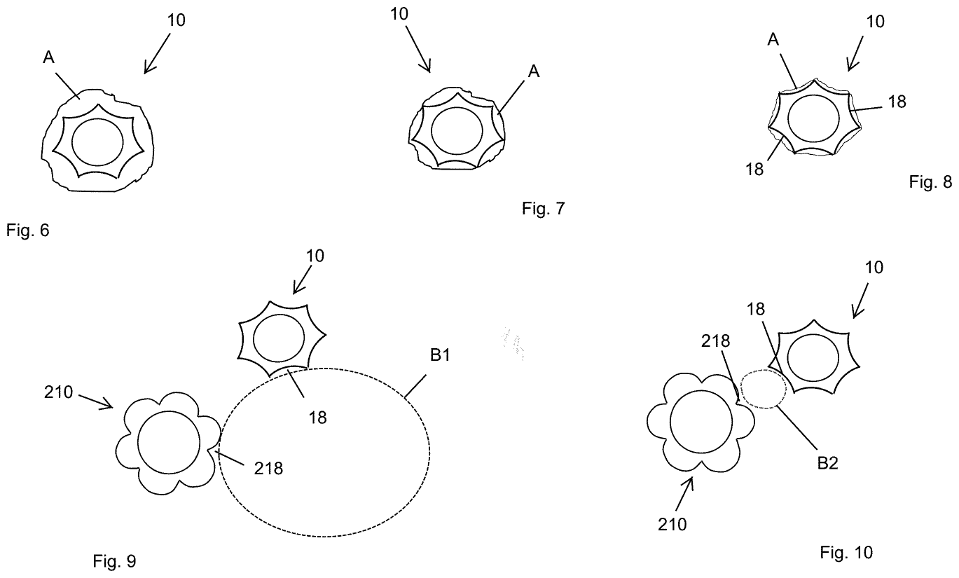

As detailed above, following a period of operation of the reactor 50, excess biofilm A may develop on the exterior surface of the fibre membranes 10, as for example illustrated in FIG. 6, which may be detrimental to the operation of the reactor 50. It is therefore necessary to carry out a controlled stripping of the excess biofilm, and the reactor 50 is therefore provided with a scour air inlet 62 which supplies scour air (or other gas) to the interior of the vessel 52, preferably at a location below or adjacent the lower end of the fibre membranes 10. In the embodiment illustrated the scour air inlet 62 terminates in a manifold 64 which is operable to generate a high volume of bubbles which pass rapidly upwardly through the vessel 52 around the membranes 10, stripping excess biofilm therefrom, a partially stripped membrane 10 being illustrated in FIG. 7. Continued passage of the scouring air bubbles will remove most of the biofilm, but as illustrated in FIG. 8, the biofilm retaining regions 18 will ensure that a relatively thin layer of biofilm will be shielded within the retaining regions 18 and will therefore not be stripped from the membrane 10. This remaining thin layer will then allow a sufficient quantity of biofilm to quickly recolonise the membranes 10 in order to allow the reactor 50 to be back to full operational capacity in a significantly reduced period of time.

In order to ensure that the scouring air does not fully strip the biofilm from the engineered retaining regions 18 the scout air inlet, and in particular the manifold, is adapted to generated bubbles whose diameter is sufficiently large, relative to the dimensions of the biofilm retaining region 18, 218 to ensure that the bubble cannot contact the nadir of the biofilm retaining regions 18, 218. This is illustrated in FIG. 9, in which a first bubble B1 is illustrated having a relatively large diameter and which cannot therefore contact the nadir of the biofilm retaining region 18, 218, ensuring that a sufficient quantity of biofilm will be protected in the region 18, 218 during the passage of the bubbles B1. Conversely FIG. 10 shows a second bubble B2 having a relatively small diameter and which can therefore contact the nadir of the retaining region 18, 218 and which would thus remove essentially all of the biofilm, significantly reducing the regrowth rate of same following the high shear cleaning of the reactor 50.

The size of the bubbles generated to scour the excess biofilm is important to the overall performance of the reactor 50. In general bubbles can be defined as being “fine”, having a diameter of less than 3 mm, or “course” having a diameter greater than 6 mm. “Micro” bubbles have a diameter less than 1 mm. Larger bubbles produce large shear stress, but there have been many studies suggesting that small bubbles can effectively control fouling in a membrane biofilm reactor, and use significantly less air flow rate and therefore energy to do so. While the effect of bubble size on fouling control in a submerged membrane reactor can vary, larger bubbles have a stronger wake and the turbulence is beneficial in promoting mixing and suppressing concentration polarization, the same being true when the dissolved pollutants in the wastewater are being consumed by the biofilm. The use of fine bubbles to mix can therefore save energy, however course bubbles are generally regarded to be better for scouring or fouling removal. In the use of a MABR both types of bubbles could be employed to achieve different results, for example to promote micro-mixing (mixing near the surface of the biofilm), scour of external layers of biofilm, and create movement of the hollow fibre membranes in the liquid, also promoting mixing.

In an exemplary embodiment of the reactor 50, the membranes should have an inner “lumen” diameter of between 100 μm and 800 μm and more preferably between 300 μm and 500 μm, with an outer diameter which encompasses the protrusions 20 of between 150 μm and 1500 μm. The protrusions 20 preferably have a height between 10 μm and 500 μm above the nadir of the biofilm retaining region 18, more preferably between 100 μm and 300 μm. The angle of separation between adjacent protrusions 20 should be no more than 120° preferably less than 90° and most preferably less than 60°. The distance between the tips of protrusions 20 should be less than 1500 μm, preferably less than 1000 μm and most preferably less than 600 μm, so that even when fine bubbles which are in the range of 1-3 mm in diameter are used for mixing or the transfer of gas to the bulk liquid, biofilm is not scoured completely from the biofilm retaining regions 18.

Bubbles used for scouring of the biofilm should be greater than 6 mm in diameter in the category of coarse bubbles, however due to the different process requirements, which bubbles can be used, i.e. biofilm control, mixing, and gas transfer, the engineered biofilm retaining regions 18 will prevent complete biofilm removal with bubbles greater than 1 mm in diameter

The present invention therefore provides a novel means by which a quantity of biofilm can be retained on a fibre membrane during a shearing or cleaning event, in order to ensure that a reactor in which the membranes are treating wastewater can be quickly operational following such an event. Using membranes with engineered protrusions extending from the surface, as well as providing engineered biofilm retaining regions therebetween, provides additional surface area for the anchoring of the biofilm. The additional surface area per unit volume of biofilm does not change the strength or the attachment properties of the biofilm, but does reduce the risk of complete removal of the biofilm from the surface of the membrane during operation, and biofilm control events. The present invention therefore addressed the problems of the prior art to provide a novel membrane, reactor incorporating the membrane, and method of treating fouling of a biofilm reactor.

What is claimed is:

1. An aerated biofilm reactor fibre membrane comprising an internal lumen from which gas can permeate through the membrane;
characterised in that at least a part of an outer surface of the fibre membrane comprises a pair of space apart protrusions which define at least one engineered biofilm retaining region therebetween, each protrusion having a height of between 10 μm and 500 μm above the nadir of the defined biofilm retaining region.

2. The fibre membrane according to claim 1, wherein the outer surface of the fibre membrane defines an array of the engineered biofilm retaining regions.

3. The fibre membrane according to claim 1, wherein the engineered biofilm retaining region of the outer surface comprises one or more concave regions.

4. The fibre membrane according to claim 1, wherein the outer surface comprises two or more substantially radially extending protrusions.

5. The fibre membrane according to claim 1, wherein the engineered biofilm retaining region of the outer surface comprises one or more substantially longitudinally extending corrugations.

6. The fibre membrane according to claim 1, wherein the outer surface of the fibre membrane is multilateral.

7. The fibre membrane according to claim 1, wherein an inner surface of the fibre membrane, which defines the lumen, is shaped to optimise gas transfer through the membrane.

8. The fibre membrane according to claim 1, wherein the fibre membrane is formed as a polymer extrusion.

9. The fibre membrane according to claim 1, wherein the lumen comprises an open end through which gas may be supplied to the lumen.

10. The fibre membrane according to claim 1, wherein the outer surface defines a cylindrical sidewall surrounding the lumen.

11. The fibre membrane according to claim 10, wherein the fibre membrane has an external diameter in the range of between 150 μm and 1500 μm.

12. The fibre membrane according to claim 1, wherein the fibre membrane comprises a gas permeable polymer.

13. The fibre membrane according to claim 1, wherein the fibre membrane comprises polydimethyl siloxane (PDMS).

14. A membrane aerated biofilm reactor comprising:
a reactor vessel;
a plurality of fibre membranes according to claim 1 located in the reactor vessel;
a liquid inlet arranged to feed a liquid to be treated into the reactor vessel; and
a liquid outlet from which treated liquid can be withdrawn from the reactor vessel.

15. The membrane aerated biofilm reactor according to claim 14, further comprising a process gas inlet for supplying a gas to the lumen of one or more of the fibre membranes.

16. The membrane aerated biofilm reactor according to claim 14, further comprising a scour gas inlet for introducing a scouring gas into the vessel to effect biofilm removal from the membranes.

17. The membrane aerated biofilm reactor according to claim 14, wherein the scour gas inlet is adapted to generate bubbles of the scouring gas.

18. The membrane aerated biofilm reactor according to claim 14, wherein the bubbles are dimensioned to have a diameter which prevents the bubbles from contacting the nadir of the biofilm retaining region of the membranes.

19. The membrane aerated biofilm reactor according to claim 14, wherein the fibre membranes are arranged in groups within the vessel.

20. A method of controlling biofilm thickness in a membrane aerated biofilm reactor which has an array of fibre membranes each comprising an internal lumen from which gas can permeate through the membrane, at least a part of an outer surface of each fibre membrane comprising a pair of space apart protrusions which define at least one engineered biofilm retaining region therebetween, the method comprising scouring excess biofilm from the external surface of the membrane using gas bubbles dimensioned to prevent contact with a nadir of the defined biofilm retaining region.
